(19) United States
(12) Patent Application Publication
(10) Pub. No.: US 2011/0252335 A1
(43) Pub. Date: Oct. 13, 2011

(54) Zooming in a Web Browser

(75) Inventors: Zachary Lloyd, Brooklyn, NY (US); Dennis J. Lee, New York, NY (US); Josh Danziger, Hoboken, NJ (US)

(73) Assignee: Google Inc.

(21) Appl. No.: 13/085,282

(22) Filed: Apr. 12, 2011

Related U.S. Application Data
(60) Provisional application No. 61/323,355, filed on Apr. 12, 2010.

(51) Int. Cl. G06F 3/01

(52) U.S. Cl. 715/744

(57) ABSTRACT

A computer-implemented method for managing the display of information in a web browser involves identifying a web browser type of a web browser on a computing device, identifying a zoom level of the web browser, obtaining size-related information about one or more graphical elements displayed by the web browser, determining a matching size for an element to be provided on the browser, and adjusting the matching size to account for zooming-related measurement errors for the identified browser type and the identified zoom level.

### CROSS-REFERENCE TO RELATED APPLICATIONS

This application claims priority to U.S. Provisional Application Ser. No. 61/323,355, filed on Apr. 12, 2010, entitled “Zooming in a Web Browser,” the entire contents of which are hereby incorporated by reference.

### TECHNICAL FIELD

This document relates to systems and techniques for managing the display of objects in a web browser at different zoom levels.

### BACKGROUND

With the development of cloud computing, more and more complex applications are being written, such as using HTML and JavaScript, to execute in web browsers, using code and data provided by central hosted services companies. Modern productivity applications, such as word processors and spreadsheets, have even been implemented with very rich user interfaces in web browsers.

Different web browser users may want to review a document like a spreadsheet at different zoom levels on their web browser. In particular, most web browsers support the ability to zoom in or out generally on the content that is displayed by the browser, such as by executing a particular key shortcut.

### SUMMARY

This document describes systems and techniques that may be used to manage the display of visual elements via a web browser, where the particular browser may include zooming functionality that is independent of the particular applications that execute in the browser. For example, the WebKit for building browsers performs certain nonstandard techniques on displayed elements when a user zooms. In zooming, the concepts of a logical pixel height and a device pixel height are relevant. The logical pixel height is what applications, such as those written in JavaScript, define to the browser. Where the zoom level is zero, the logical pixel height and the device pixel height are the same. However, as zoom increases, the device pixel height gets greater and becomes a multiple of the logical pixel height. In WebKit, each increase zoom level is 1.2 over the prior level.

Thus, for example, if JavaScript asks for an element 11 pixels high and the browser is at zoom level 1, the browser will compute the request as 13.2 pixels but round it down to 13 pixels because partial pixels cannot be displayed. If many such elements are stacked, the rounded error for the entire height of the stack can quickly become relevant, particularly when a distance is made up of a large number of smaller distances, and particularly at higher zoom levels.

Thus, as described here, when a browser is determined to use a system like WebKit, the particular math used in such a system may be reverse engineered in effect by the features here, so that the inputs provided to a device may be adjusted so that the WebKit renders, even at a zoomed in level, in an appropriate manner.

In one implementation, a computer-implemented method for managing the display of information in a web browser is disclosed. The method comprises identifying a web browser type of a web browser on a computing device, identifying a zoom level of the web browser, obtaining size-related information about one or more graphical elements displayed by the web browser, determining a matching size for an element to be provided on the browser, and adjusting the matching size to account for zooming-related measurement errors for the identified browser type and the identified zoom level.

In another implementation, a computer-implemented system for managing the electronic display of information is disclosed. The system comprises a web browser; an electronic document that is accessible for display on the web browser; and an application configured for execution on the web browser, the application programmed to identify a type of the web browser, identify a zoom level of the web browser, obtaining size-related information about one or more graphical elements for display by the web browser, determining a matching size for an element to be provided on the browser, and adjusting the matching size to account for zooming-related measurement errors for the identified browser type and the identified zoom level. The application can be further programmed to request the browser to generate the element to be provided on the browser at the adjusted matching size. Also, the application can be programmed to obtain size-related information about one or more graphical elements for display by the web browser by accessing a model of the electronic document. Moreover, identifying a zoom level of the web browser can comprise submitting a query to the browser form an application that is running on the browser.

The details of one or more embodiments are set forth in the accompanying drawings and the description below. Other features and advantages will be apparent from the description and drawings, and from the claims.

### DESCRIPTION OF DRAWINGS

FIG. 1 shows zoomed examples of tables from a web browser,

FIGS. 2A and 2B are block diagrams showing components of a model-view-controller implementation of a spreadsheet application.

FIG. 2C is a block diagram of a system for permitting collaborative editing of a documented by multiple users through a hosted server system.

FIG. 3 is a flow chart for providing adjustments to graphical items in a web browser display so as to permit proper alignment of such items with other items.

FIG. 4 shows an example of a computer device and a mobile computer device that can be used to implement the techniques described here.

Like reference symbols in the various drawings indicate like elements.

### DETAILED DESCRIPTION

This document describes systems and techniques for managing idiosyncrasies with respect to distance measure and layout in a web browser during native zooming I the browser.

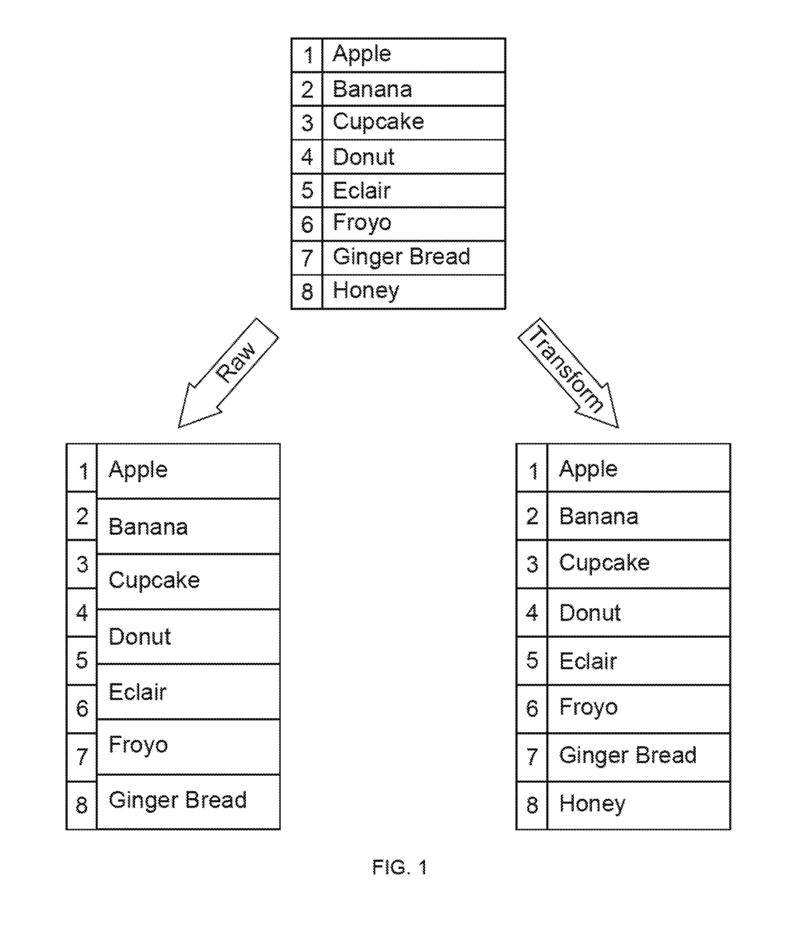

FIG. 1 shows zoomed examples of tables from a web browser. In this example, a table (which shows numbers next to names of deserts) may be formed visually by the generation of two adjacent elements that look like joined columns. At a zero zoom level, the elements align very well, as shown at the top of the figure. However, when the browser is zoomed in, the elements may become unaligned, as shown in the left branch. This may happen, for example, because an application that is responsible for generating the right column to match the left column may request information from the browser regarding the particular rows in the left column. Because of the problems with zooming in certain browsers, the information returned by the particular browser may not be wholly accurate. Thus, on the right branch, the application has received added logic so as to transform the input it receives regarding the sizes of the rows in the left column (from the browser), and adjusts its own rendering of rows to make up for such problems.

The following figures describe browser modeling structure and a collaborative system in which the techniques described here may be particularly useful. For example, where multiple users are editing a document at the same time, it can be important for them to be synchronized with each other, and lack of alignment in data in such a situation may create real problems.

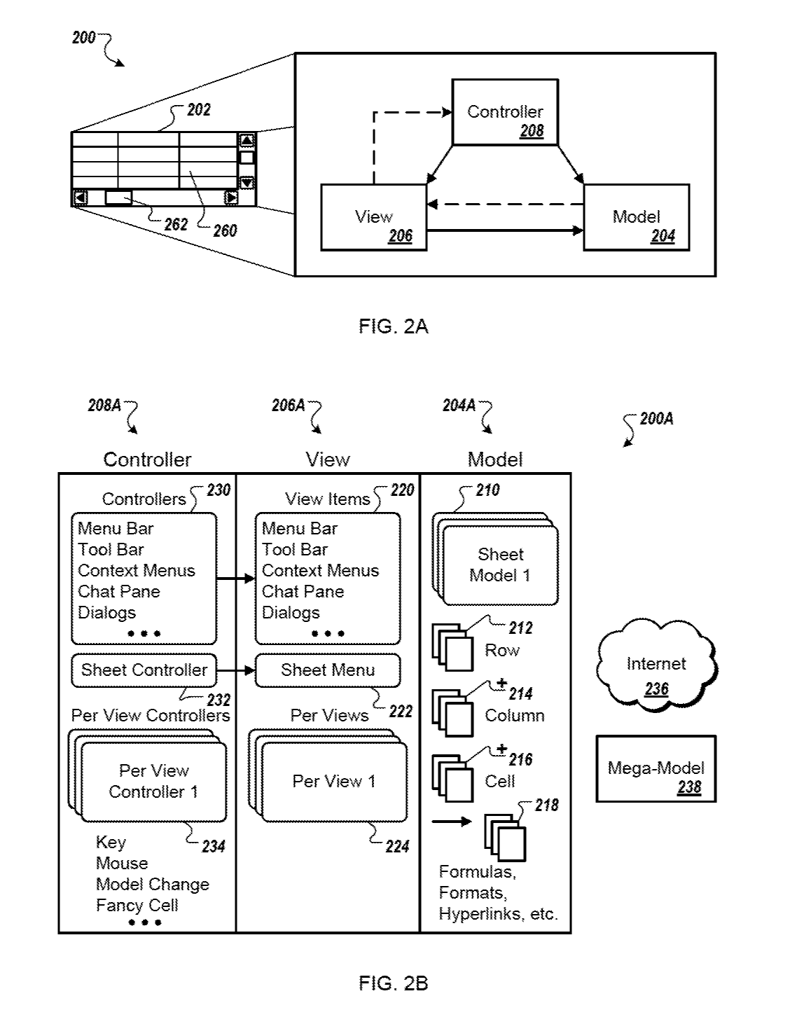

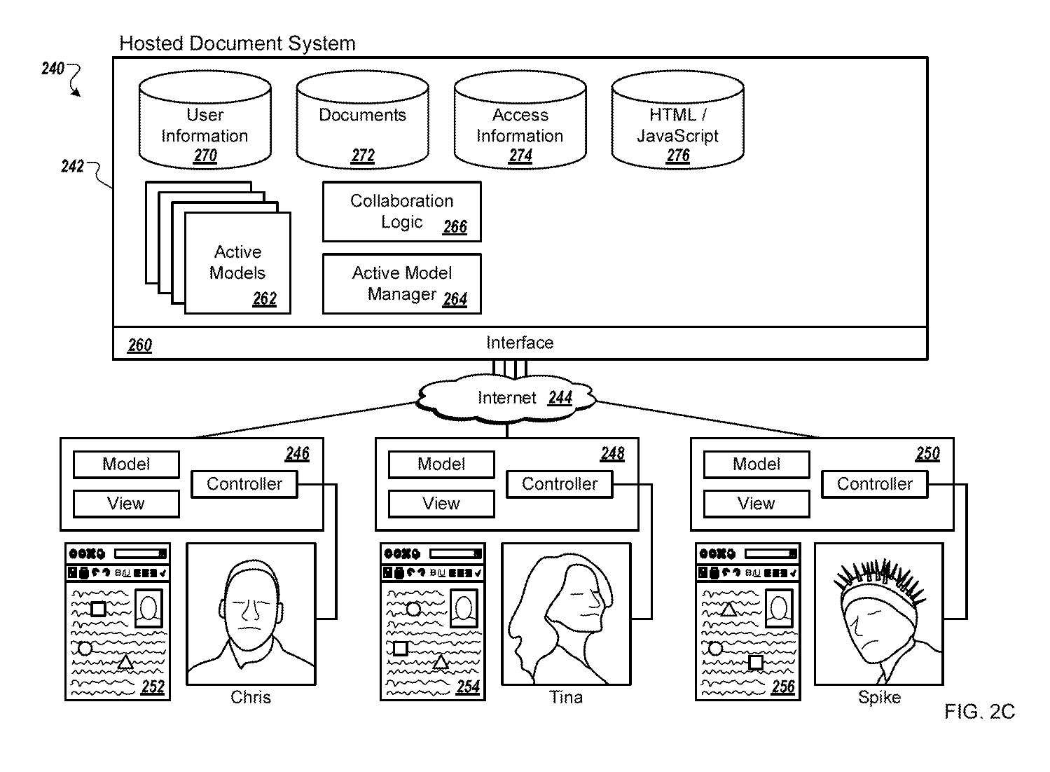

FIGS. 2A and 2B are block diagrams showing components of a model-view-controller (MVC) implementation of a spreadsheet application. For example, the spreadsheet application may be executed by a web browser, such as the web browser 102 shown in FIG. 1. In general, the MVC implementation provides for the download of a model from a remote server to a client, and the rendering of the client into a DOM to form a view of the model that may be managed directly by the web browser. The controller may intercept actions, such as clicks on icons and keystrokes on a keyboard, and may cause such actions to be implemented, such as by adding typed characters both to the model on the client and on the remote server.

Referring to FIG. 2A, a computer application 200 may be configured to display a spreadsheet document 202. The application 200 includes a model 204, a view 206, and a controller 208. For example, the model 204 can contain a representation of the state of the spreadsheet document 202, including such elements as values, formats, formulas, frozen columns, hidden columns, frozen rows, hidden rows, and the like. The view 206 can represent a rendering of the current state of the model 204. For example, the view 206 can be used for presenting to the user visual information that is associated with the spreadsheet document 202, such as user controls and spreadsheet data. The controller 208 can respond to changes in the model 204 or the view 206, and can update the state of the model 204 and the view 206. As shown in FIG. 2A, solid lines between the model 204, the view 206, and the controller 208 represent direct references between components, and dashed lines represent listeners. For example, listening for user interaction (e.g., provided by user controls) with the presentation of the view 206, the controller 208 can modify the model 204, and can in turn modify the view 206. As another example, listening for changes in the model 204 made by another user in a collaborative environment or changes made through an automated data update or another such process, the view 206 can request re-rendering of an updated model or portion of the model. For example, if a user of a client device is only one of multiple users concurrently editing a document, characters and other edits by the other users may be passed to the client device from the server system, and the client code may add characters to the model in near real-time, and those changes can be passed into the DOM—so that each user can see the edits made by the other users very quickly.

Referring to FIG. 2B, the model-view-controller implementation as presented in FIG. 2A is shown with additional detail. As shown, a computer application 200A includes a model 204A (corresponding with the model 204), a view 206A (corresponding with the view 206A), and a controller 208A (corresponding with the controller 208A).

The model 204A can include one or more sheet models 210. Each of the sheet models 210 can represent a separate spreadsheet in a collection of spreadsheet documents, for example, and can include a set of row models 212 and column models 214. For example, the row models 212 and the column models 214 can be represented as arrays. Each of the sheet models 210 can further include a set of cell models 216. For example, the cell models 216 can be represented as a sparsely populated two-dimensional array indexed by row and column ids. In some implementations, each of the sheet models 210 can include additional metadata, such as information related to frozen rows and columns, hidden rows and columns, merges, conditional formats, embedded object managers, maps of ids to positions, and the like.

Each of the cell models 216 can include a set of cell components 218. For example, each of the cell components 218 can include information such as cell types, raw values, display values, format models, formula models, hyperlinks, data validation, conditional formatting, mutation methods, and view annotations (e.g., properties that may be cached on cell objects for lookup). In some implementations, each cell type (e.g., text, hyperlink, comment, and the like) may include an associated renderer that may convert the cell to an HTML/DOM (HyperText Markup Language/Document Object Model) representation via rendering. Format models may include such properties as number formats, cell styling including colors and fonts, and the like. Formula models may also include formulas using R1C1 notation, and may include methods for formula conversion. Format models can be implemented using Cascading Style Sheet (CSS) classes, CSS class maps, and inline style objects, for example. Formula models can be stored in a map on a client device, for example, so that cells may share references to the formulas. In some implementations, format models may also be stored in a map on a client device. In some implementations, cell models and format models may follow the NULL object pattern. For example, shared singleton objects may exist for a default blank cell and for a default blank format. Model data and components may be provided by a mega-model 238 (whose name indicates that the model is a super-set of the other models or views) stored on a remote server system via a connection to a network 236 (e.g., the internet).

The view 206A can include one or more view items 220 that may enable the user to interact with the application 200, such as menu bars, tool bars, context menus, chat panes, dialogs, and the like. The view 206A can also include a sheet menu 222 that presents information and control options related to one or more of the sheet models 210, and one or more of a set of per views 224. For example, one of the per views 224 may be associated with a corresponding one of the sheet models 210. Each of the per views 224 may include components or controls such as freezebars, resizers, selectors, active cell indicators, and navigation tools (e.g., scrollbars and the like).

The controller 208A can include one or more controllers 230 that may listen for and handle user interactions with one or more of the view items 220. In some implementations, each of the controllers 230 may be associated with a corresponding one of the view items 220. For example, menu bar controllers may listen for and handle user interactions with menu bar view items (e.g., relating to various actions that a user would typically take fro ma row of menu selections), tool bar controllers may listen for and handle user interactions with tool bar view items, context menu controllers may listen for and handle user interactions with context menu view items, and so forth.

The controller 208A can also include a sheet controller 232 that may listen for and handle user interactions with the sheet menu 222. In addition, the controller 208A can include a set of per view controllers 234, where each of the controllers 234 is configured to listen for and handle user interactions with a corresponding view in the set of per views 224. Each of the per view controllers 234 may include various controller types, such as key controllers for intercepting and interpreting keyboard input, mouse controllers for intercepting and interpreting mouse input, and model change controllers for intercepting and interpreting model change events.

Generally, the controllers included in the controller 208A can transform user-generated events into model and view mutations. For example, based on a user action, a relevant controller (e.g., a controller configured for handling the action) may receive one or more events associated with the action and make transient changes to the view 206A before the user action is committed. Then, based on the event properties, the relevant controller can construct a command to mutate the model 204A, execute it, and send it to the remote server system that hosts the mega-model 238 via the network 236.

Many possible user interactions with the application 200A are possible, including interactions included in single-user sessions and in multiple-user sessions. For purposes of illustration, a series of example user interactions with the application 200A are described here. For example, to enter data into the spreadsheet document 202, the user may proceed by using a computer mouse to select a desired spreadsheet cell 260 by clicking on the cell. A mouse controller included in the per view controllers 234 (e.g., a per view controller associated with the active sheet of the document 202) can listen for an event associated with the mouse positioning input and the mouse click input, and upon intercepting it, can modify the view 206A (e.g., a per view associated with the active sheet) to provide the user with a visual indicator for the selection. For example, the selected spreadsheet cell 260 may be highlighted, assigned a different border, assigned a different color, or another such modification.

Using a keyboard, the user may enter a desired value into the spreadsheet cell 260. A keyboard controller included in the per view controllers 234 can listen for events associated with the keyboard input, and upon intercepting them, can modify the view 206A to provide the user with a visual indicator for the input. For example, as the user types data into the spreadsheet cell 260, the cell may be visually updated to present the data to the user. Additionally, the keyboard controller can modify the model 204A to include entered data by writing the user input to the model. For example, one of the cell models 216 (e.g., a cell model associated with the spreadsheet cell 260) can be updated to include the entered data as the raw value. Additionally, the mega-model 238 may be updated to include the entered data, thus coordinating the model 204A with the mega-model 238. For example, changes to the model 204A may be transmitted to the mega-model 238 via a connection to the network 236. In some implementations, changes may be sent periodically (e.g., once every second, once every 10 seconds, once every minute, or another appropriate time interval). In some implementations, changes may be sent based on user activity (e.g., removing focus from a spreadsheet cell, clicking a save button, or some other action).

Next, for example, the user may modify the formatting of data presented in the spreadsheet cell 260. By interacting with one of the view items 220 or with the sheet menu 222, the user can indicate a desired formatting change (e.g., a change such as changing regular numbers to currency, changing a font to bold, changing a color to blue, and the like). One of the controllers 230 or the sheet controller 232 can listen for user interaction with the view 206A, and upon detecting the interaction, can modify the model 204A to include the formatting change. For example, one of the cell models 216 (e.g., the cell model associated with the spreadsheet cell 260) can be updated to include the change. A model change controller included in the per view controllers 234 can listen for events associated with the model 204A and can send a request to the view 206A to update accordingly (e.g., by rendering a display value included in the cell model associated with the spreadsheet cell 260). In some implementations, the model change controller may also handle model change events that result from collaborative model changes.

Additionally, for example, the user may associate the spreadsheet cell 260 with a formula. Model-view-controller interactions within the application 200A for entering the formula and associating the formula with the spreadsheet cell 260 may be generally similar as when modifying formatting. For example, a model change controller included in the per view controllers 234 can detect the model change associated with the entered formula, and can send a request to the view 206A to perform a display update. As part of the display update, for example, the view 206A may convert the entered formula to a literal value, and may render the spreadsheet cell 260 to include the literal value.

Particular steps may be taken to permit a user to interact with a formula for a cell when the view might only include a literal value for the cell. In such a situation, a text entry area or box may be display adjacent to a viewport on a browser, and when a user places a cursor over a particular cell, the model data for the cell may be obtained and provided in the text entry area, while the literal value is shown in the cell in the viewport. As the user changes the formula, that change may be propagate to the model on the client (with changes to downstream cells) and may be rendered back into the DOM.

The user may also elect to view a different portion of the spreadsheet document 202 than they are currently viewing in the viewport. For example, by interacting with a scrollbar 206 that is associated with the spreadsheet document, the user may indicate a desire to view spreadsheet data beyond the current view. One of the per view controllers 234 (e.g., the per view controller associated with the active sheet) can listen for user interaction with the view 206A or other appropriate component (e.g., the visual portion of the scrollbar 262), and upon detecting the interaction (e.g., via a computer mouse), can request for the view 206A to redraw itself. If the user specifies a small amount of scrolling, the view 206A may cause itself to be displayed by the browser. For example, a buffer area of cells may be maintained in the model 204A around the cells displayed in the visible area of the spreadsheet document 202. If the amount of scrolling specified by the user is determined by the view 206A to be within the bounds of the buffer area of cells, the spreadsheet cells may be rendered using the cached data. If the user specifies a larger amount of scrolling, such that the scrolling specified by the user is determined by the view 206A to be outside of the bounds of the buffer area of cells, for example, additional spreadsheet data from the mega-model 238 may be downloaded via the network 236. Thus, the model 204A may be updated with information related to additional spreadsheet cells, and the spreadsheet cells may be rendered using the downloaded data.

FIG. 2C is a block diagram of a system 240 for permitting collaborative editing of a document by multiple users through a hosted server system. In general, the system 240 includes a hosted document system 242 executed by one or more computer servers (e.g. a server farm). The hosted document system 242 can provide document hosting services to any number of client users via connections to a network 244 (e.g., the internet). Using the document system 242, client users may create new documents, modify existing documents, share documents, and collaboratively work on documents with other users.

For purposes of illustration, document hosting services may be provided to browser applications 246, 248, and 250. Each of the applications may be executed by a web browser (e.g., by the browser 104, as shown in FIG. 1), and may include model, view, and controller components (e.g., similar to the application 200, shown in FIGS. 2A and 2B). The applications 246, 248, and 250 may be configured to execute computer code (e.g., JavaScript and other code running in a web browser) to display a word processing interface and to perform word processing functions associated with one or more documents served by the hosted document system 242.

As shown in the present illustration, Chris can interact with a web browser 252, Tina can interact with a web browser 254, and Spike can interact with a web browser 256. Each of the browsers 252, 254, and 256 may access any appropriate number of browser applications (e.g., embedded applications, widgets, web services, and the like). For example, browser 252 can access application 246, browser 254 can access application 248, and browser 256 can access application 250.

By interacting with controls presented by the web browsers, for example, users of the system 240 (e.g., Chris, Spike, and Tina), can work with one or more documents that are managed and provided by the hosted document system 242. For example, the users may access existing documents provided by the system 242 or may create new documents. Each of the browser applications 246, 248, and 250 can communicate with an interface 260 of the document system 242 via the network 244. For example, communication between the browser applications 246, 248, and 250 and the interface 260 may include HTTP (HyperText Transfer Protocol) requests, SOAP (Simple Object Access Protocol) messages, or some other appropriate such protocol. In some implementations, client browsers may maintain browser channel connections to the interface 260 for communicating session data between clients and the document system 242.

The hosted document system 242 can include sub-components for storing and managing information related to system users, documents, and browser applications. The various sub-components may be executed by the same computer server, or may be distributed among multiple computer servers. The sub-components may communicate with each other directly (e.g., via messages, transferred files, shared data, remote procedure calls, or some other protocol) or indirectly (e.g., by communicating with an intermediary application). Generally, sub-components included in the document system 242 can communicate with client applications (e.g., the browser applications 246, 248, and 250) via the interface 260.

The system 242 can also include one or more data stores for storing user information 270. For example, the user information 270 can include information associated with system users (e.g., Chris, Tina, and Spike). Such information may include general user information and login information (e.g., user names, passwords, e-mail addresses, and the like), information related to one or more devices employed by the users to access the system (e.g., IP addresses, browser versions, connection speeds, and the like), and system usage information (e.g., access times, amount of data accessed, and the like), to name a few possibilities.

In some implementations, the system 242 can include one or more data stores for storing documents 272 in the form, e.g., of document models like those discussed above and below. For example, the documents 272 can include word processing documents created, maintained, and accessed by system users. As another example, the documents 272 may be generated by an automated process, such as a news feed or another reporting process that is based on gathered data. Information associated with the documents 272 can include document data models, document text, document formatting information, entities (e.g., tables, images, videos, sound clips, or other such objects), and the like.

The system 242 can also include one or more data stores for storing access information 274. For example, the access information 274 can include information that can be used for controlling access of system users (e.g., users included in the user information 270) to system documents (e.g., documents included in the documents 272). Generally, system users may set access privileges for documents that they create or manage. For example, Chris may create a personal letter document and specify the document as being private. Thus, other users of the system (e.g., Tina and Spike) may be unable to locate or access the document, which may have access control limitations applied to it in various familiar manners. As another example, Tina may upload a schedule document and specify the document as being shared and as being viewable by Chris. Thus, Spike may be unable to locate or access the document, but Chris may be able to access the document in view-only mode. In some implementations, Tina, as the document creator, may retain full access to the document, having privileges such as the ability to add, edit, and delete content, having the ability to change privileges, and having the ability to remove the document from the system 242. As another example, Spike may create a document related to a group project and specify Chris and Tina (and himself) as having full access privileges. In some implementations, user groups may be included in the access information 274. For example, a user may create a group and may add one or more users to the group. Rather than select individual users when assigning document permissions, in some instances, users may select a group including the users. The access information 274 may also include such information as the user ids of document users, document access times, and the like.

In some implementations, the system 242 can include one or more data stores for storing HTML/JavaScript 276. For example, the HTML/JavaScript 276 can include application code for executing the browser applications 246, 248, and 250. The application code may be provided to any of the browsers 252, 254, and 256, for example, when browser users access a web site associated with the hosted document system 242. Upon receiving a request for any of the documents 272, for example, the system 242 may provide the HTML/JavaScript 276 in addition to one or more of the documents 272. Using the HTML/JavaScript 276, the browser applications 246, 248, and 250 may render the document data and may provide an interface that enables browser users to interact with the documents. In some implementations, technologies other than HTML and JavaScript may be used for providing application code. For example, for web browsers including an appropriate plugin, another type of compiled or interpreted code may be provided.

Many possible user interactions with the system 240 are possible, including interactions in single user sessions and in multiple user sessions. For example, in a collaborative editing session, multiple users may simultaneously interact with a document. Although the applications used for editing the document may each behave independently, the applications may follow the same editing rules for updating and rendering the document model. Thus, multiple users may have similar experiences with the document, and may work together to produce a similar document model.

In an example session, to initiate collaborative word processing document editing, Chris accesses the hosted document system 242 by directing the web browser 252 to a web site (e.g., a domain) that is associated with the system 242. Receiving login information from the browser 252, the system 242 can verify Chris's information against the user information 270. Upon verification, the system 242 can provide HTML/JavaScript 276 to the browser 252 for executing an online word processor (though certain of the code may be passed before verification occurs). The browser can include a portion of the HTML/JavaScript 276 as the browser application 246, render chrome associated with the application, and display the application to Chris.

Chris may interact with the browser application 246 via a set of controls displayed in an application view within the browser 252. For example, Chris may indicate an intent to create a new document by clicking a button or selecting a menu option displayed in the application view. The application controller can intercept the command and pass the command to the interface 260 via the network 244. Receiving the command, the system 242 can add a new document to the documents 272, and add information associated with the new document to the set of active models 262. For example, the active models 262 may include model information associated with documents currently being edited by other users of the system 242.

A corresponding version of a model in the set of active models 262 may be present at the browser application 246. For example, Chris may add content and make changes to the word processing document provided by the view of the browser application 246, and the corresponding content and changes can be applied to a model that is accessed by the browser application 246 (and associated HTML and JavaScript code running in the browser), and may be propagated to the active models 262.

Chris may also share the document with one or more users. For example, using controls associated with the application 246, Chris may select Tina and Spike as users who may share the document, and he may assign both Tina and Spike full document privileges. For example, Tina and Spike may be included in a presented list of users commonly sharing documents with Chris, and Chris may select Tina and Spike from the list. As another example, Chris may provide the e-mail addresses of Tina and Spike. The system 242 can store the sharing information (e.g., user ids of other users having access to the document, permissions levels for the users, and the like) in the access information 274. In some implementations, the system 242 may send messages (e.g., e-mail, text messages, instant messages, and the like) to users who have received document privileges. In some implementations, users who have received document privileges may receive a link (e.g., a hyperlink or URL) to the shared document.

Upon receiving notification of the shared document, Tina and Spike may access the document using their web browsers 254, 256. For example, upon verification, the system 242 can provide HTML/JavaScript 276 to the browser 254, 256 for executing an online word processor. The browsers can include a portion of the HTML/JavaScript 276 as the browser applications 248, 250, can render chrome associated with the application, and can display the applications.

Additionally, an active model manager 264 included the hosted document system 242 can identify which documents are currently open by users of the system, and users who are active in the document (i.e., Chris), and can set up a collaborative session. For example, the active model manager 264 can determine that the document requested by Tina and by Spike is associated with one or more of the active models 262. The system 242 can then forward the document request to a computer hosting the document, and the computer can associate Tina and Spike with the current session. Additionally, the browser applications 248, 250 can download model data associated with the active model(s) 262, and render and display the downloaded model data. In some implementations, the system 242 can create model instances for Tina and for Spike and can add the instances to the active models 262.

In the present example, users may be able to view their own cursors as well as the cursors of other users in a collaborative session. For purposes of illustration, each user's cursor appears to himself/herself as a square. For example, Chris may view his own cursor as a square, and the other users' cursors as a circle or as a triangle. Correspondingly, Tina and Spike may also view their own cursor as a square, and the other users' cursors as circles or triangles. In some implementations, the cursors may appear as a different color (which could not be shown here). For example, cursors may generally appear as underlines or vertical bars, where the cursors are different colors for each user.

In the present example, changes made by each of the users can be sent by the browser applications 246, 248, and 250 to the hosted document system 242, coordinated, and sent back to the other users. In some implementations, the changes can be sent at time intervals (e.g., once every 100 milliseconds, once every 200 milliseconds, once every 500 milliseconds, once every second, once every 2 seconds, or another appropriate time interval). In some implementations, sending can be based at least in part on user activity or inactivity. For example, during periods of user inactivity, changes may be sent or received less frequently than during periods of user activity. When a user is entering data or when a local user hovers over a cursor for another user, a pop-up label that identifies the other user may be displayed, so that the local user can identify who is making changes—though the label may then disappear so that it does not continue to block the document.

To coordinate multiple document changes made by multiple users, for example, the hosted document system 242 can include collaboration logic 266. For example, the collaboration logic 266 can be executed by one or more code modules executed by one or more computer servers associated with the system 242. In some implementations, portions of the collaboration logic can be executed by the browser applications 246, 248, and 250. Generally, the logic 266 can resolve data collisions (e.g., instances where multiple users edit the same document portion or apply conflicting document formats) by applying a consistent set of rules to all user changes. Although, in some instances, one or more users may be prompted to disambiguate a change. For example, if Tina makes a document change and Spike makes a conflicting document change before receiving Tina's change, Spike may be presented with a message from the browser application 250 including possible conflict resolution scenarios. In some implementations, one user may be identified as trumping other users in collision situations. Chris, as the document creator, for example, may be able to apply his changes over changes made by either Tina or Spike in cases of conflict. For example, if Spike edits a passage at the same time as Chris deletes it, the passage (including Spike's edits) may be deleted.

Thus, the system shown in FIG. 2C may handle collaborative editing of a hosted document by multiple users at one time. The management of such editing can involve a low amount of data passing between the various sub-systems in the system

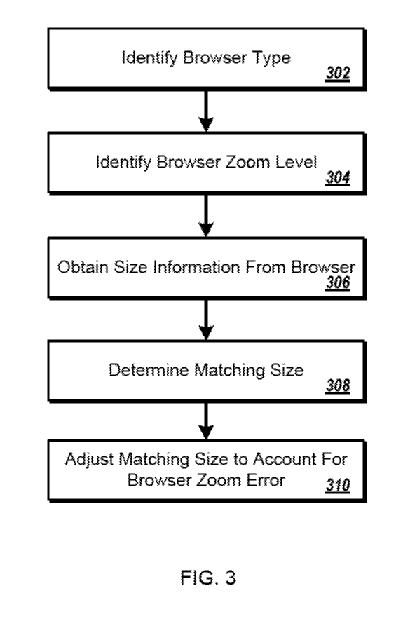

FIG. 3 is a flow chart for providing adjustments to graphical items in a web browser display so as to permit proper alignment of such items with other items. The disclose process may be implemented, for example, using the systems and techniques described above with respect to FIGS. 2A-2C.

The process begins at box 302, where a browser type is identified. The browser type may be used by the program to determine whether any size adjustments will need to be made in its output so as to align properly with whatever else the browser may be displaying. At box 304, a current browser zoom level is determined, where 0 is no zoom at all, and high zoom levels correspond to higher degrees of zooming in and enlarging displayed items.

At box 306, the process obtains size information from the browser. For example, the application may want to determine where to place a digital image in a document relative to a number of rows of text. The application may thus make typical requests to get information about the heights of each row of text, and then may aggregate to determine composite distances. At box 308, the application determines a size of an element it would have to generate in order to match with the existing elements, as those elements were repeated by the browser. Finally, at box 310, the process adjusts the determined matching size by essentially backing out whatever special mathematics the browser performed in making its calculations.

Thus, the process just described may enable a developer of a complex application to define much better how the application will look, and will interact with a user. Also, seamless graphical user interfaces may be more easily generated with the techniques discussed here, as visual disconnects and misalignments can be avoided on a browser display.

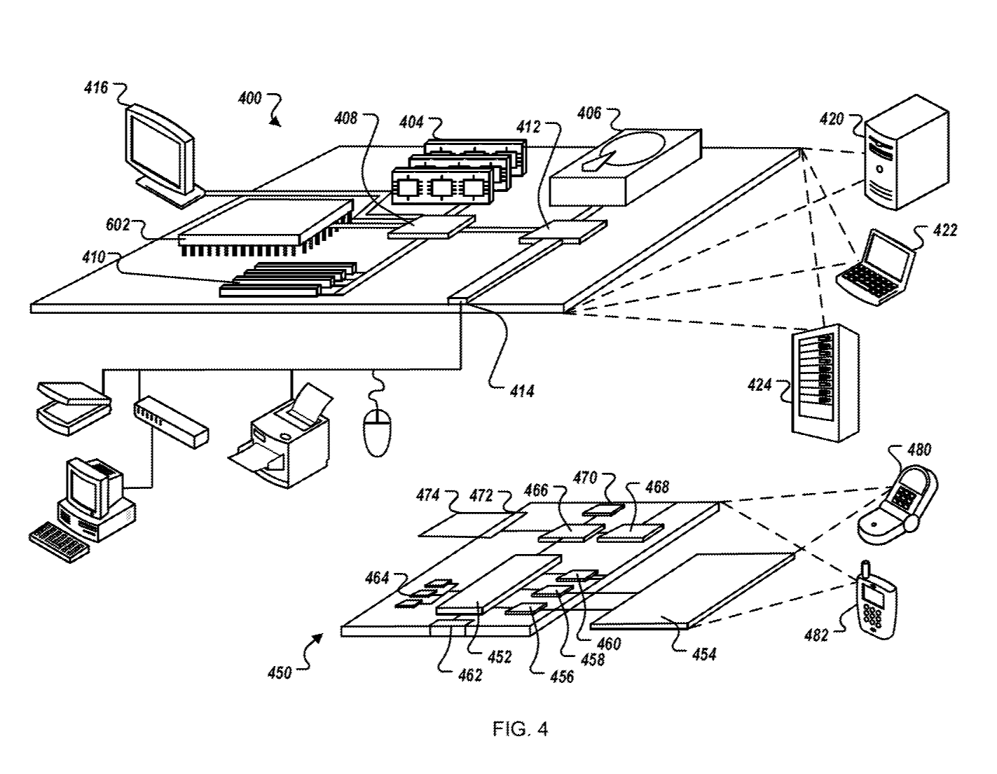

FIG. 4 shows an example of a generic computer device 400 and a generic mobile computer device 450, which may be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, memory on processor 402, or a propagated signal.

The high speed controller 408 manages bandwidth-intensive operations for the computing device 400, while the low speed controller 412 manages lower bandwidth-intensive operations. Such allocation of functions is exemplary only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to device 450 through expansion interface 472, which may include, for example, a SIMM (Single In Line Memory Module) card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, memory on processor 452, or a propagated signal that may be received, for example, over transceiver 468 or external interface 462.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS (Global Positioning System) receiver module 470 may provide additional navigation- and location-related wireless data to device 450, which may be used as appropriate by applications running on device 450.

Device 450 may also communicate audibly using audio codec 460, which may receive spoken information from a user and convert it to usable digital information. Audio codec 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method for managing the display of information in a web browser, the method comprising:
identifying a web browser type of a web browser on a computing device;
identifying a zoom level of the web browser;
obtaining size-related information about one or more graphical elements displayed by the web browser;
determining a matching size for an element to be provided on the browser; and
adjusting the matching size to account for zooming-related measurement errors for the identified browser type and the identified zoom level.

2. The computer-implemented method of claim 1, wherein the size-related information and the adjusted size are expressed in units of pixels.

3. The computer-implemented method of claim 1, further comprising requesting, with an application running in the browser, the browser to generate the element to be provided on the browser at the adjusted matching size.

4. The computer-implemented method of claim 1, wherein determining a matching size for an element to be provided on the browser comprises aggregating sizes of multiple adjacent elements to be displayed by the web browser.

5. The computer-implemented method of claim 1, wherein obtaining size-related information about one or more graphical elements displayed by the web browser comprises accessing an unrendered model of an electronic document.

6. The computer-implemented method of claim 1, wherein obtaining size-related information about one or more graphical elements displayed by the web browser comprises accessing a document object model (DOM) of an electronic document.

7. The computer-implemented method of claim 1, wherein identifying a zoom level of the web browser comprises submitting a query to the browser form an application that is running on the browser.

8. The computer-implemented method of claim 1, wherein adjusting the matching size to account for zooming-related measurement errors for the identified browser type and the identified zoom level comprises mapping a logical pixel height to a device pixel height.

9. One or more tangible computer-readable storage media storing instructions that, when executed on one or more computers, perform operations comprising:
identifying a web browser type of a web browser on a computing device;
identifying a zoom level of the web browser;
obtaining size-related information about one or more graphical elements displayed by the web browser;
determining a matching size for an element to be provided on the browser; and
adjusting the matching size to account for zooming-related measurement errors for the identified browser type and the identified zoom level.

10. The tangible computer-readable storage media of claim 9, wherein the size-related information and the adjusted size are expressed in units of pixels.

11. The tangible computer-readable storage media of claim 9, wherein the operations further comprise requesting, with an application running in the browser, the browser to generate the element to be provided on the browser at the adjusted matching size.

12. The tangible computer-readable storage media of claim 9, wherein determining a matching size for an element to be provided on the browser comprises aggregating sizes of multiple adjacent elements to be displayed by the web browser.

13. The tangible computer-readable storage media of claim 9, wherein obtaining size-related information about one or more graphical elements displayed by the web browser comprises accessing an unrendered model of an electronic document.

14. The tangible computer-readable storage media of claim 9, wherein obtaining size-related information about one or more graphical elements displayed by the web browser comprises accessing a document object model (DOM) of an electronic document.

15. The tangible computer-readable storage media of claim 9, wherein identifying a zoom level of the web browser comprises submitting a query to the browser form an application that is running on the browser.

16. The tangible computer-readable storage media of claim 9, wherein adjusting the matching size to account for zooming-related measurement errors for the identified browser type and the identified zoom level comprises mapping a logical pixel height to a device pixel height.

17. A computer-implemented system for managing the electronic display of information, the system comprising:
a web browser;
an electronic document that is accessible for display on the web browser; and
an application configured for execution on the web browser, the application programmed to identify a type of the web browser, identify a zoom level of the web browser, obtaining size-related information about one or more graphical elements for display by the web browser, determining a matching size for an element to be provided on the browser, and adjusting the matching size to account for zooming-related measurement errors for the identified browser type and the identified zoom level.

18. The computer-implemented system of claim 17, wherein the application is further programmed to request the browser to generate the element to be provided on the browser at the adjusted matching size.

19. The computer-implemented system of claim 17, wherein the application is programmed to obtain size-related information about one or more graphical elements for display by the web browser by accessing a model of the electronic document.

20. The computer-implemented method of claim 1, wherein identifying a zoom level of the web browser comprises submitting a query to the browser form an application that is running on the browser.
